(19) United States
(12) Patent Application Publication
(10) Pub. No.: US 2024/0119095 A1
(43) Pub. Date: Apr. 11, 2024

(54) SEARCH SYSTEM THAT PROVIDES SEARCH RESULTS AND GENERATED CONTENT

(71) Applicant: Microsoft Technology Licensing, LLC, Redmond, WA (US)

(72) Inventors: Arun Kumar SACHETI, Sammamish, WA (US); Nevin YANG, La Mirada, CA (US); Meenaz Aliraza MERCHANT, Kirkland, WA (US); Parthasarathy GOVINDARAJEN, Sammamish, WA (US); Jeff R. DEVRIES, Seattle, WA (US); Jason Blake FISCHEL, Mercer Island, WA (US)

(21) Appl. No.: 17/963,993

(22) Filed: Oct. 11, 2022

(51) Int. Cl. G06F 16/951; G06F 16/9535; G06F 16/9538

(52) U.S. Cl. CPC G06F 16/951; G06F 16/9535; G06F 16/9538

(57) ABSTRACT

A computing system is described, where the computing system includes a processor and memory storing instructions that, when executed by the processor, cause the processor to perform several acts. The acts include receiving a query from an application executing on a client computing device that is in network communication with the computing system. The acts also include searching a computer-readable index of items based upon the query, identifying an item based upon the searching of the computer-readable index, transmitting the query to a computer-implemented model, and obtaining content generated by the computer-implemented model, where the computer-implemented model generated the content based upon the query. The acts further include returning at least one of the item or the content to the client computing device for presentment by way of the application executing on the client computing device.

### BACKGROUND

A computer-implemented search engine conventionally receives a query from a client computing device operated by user, searches a computer-readable index of items (webpages, images, videos, etc.) based upon the query, identifies items from the index that are relevant to the query, ranks the items to create a ranked list, and returns a search engine results page (SERP) to the client computing device, where the SERP includes the ranked list of items. While search engine technology is continuously improving with respect to inferring intent of users based upon queries issued by the users, a conventional search engine is limited to identifying items that have been indexed and/or stored by the search engine based upon a user query. When the search engine receives a query set forth by a user that accurately reflects an information retrieval intent of the user, but the search engine has not index and/or stored items that are relevant to that intent, the search engine either returns nothing to the user or returns results that are irrelevant.

### SUMMARY

The following is a brief summary of subject matter that is described in greater detail herein. This summary is not intended to be limiting as to the scope of the claims.

Described herein are various technologies pertaining returning search results to a user in response to receipt of a query from the user, where the search results can include both: 1) items that have been previously indexed and/or stored; and 2) content that has been generated by a computer-implemented model based upon the query. With more particularity, a computing system receives a query from an application executing on a client computing device that is in network communication with the computing system. The application can be a web browser, a mobile search engine application, a productivity application (such as a word processing application, an email application, a spreadsheet application, a slide presentation application, etc.).

Based upon the query, the computing system searches a computer-readable index of items to identify items that are related to the query. The items can be webpages, images, videos, etc. The computing system can identify an item indexed in the computer-readable index based upon the query. In addition, the computing system can perform operations related to generating content based upon the query (where, in the context of content generation, the query may be referred to as a prompt). In an example, a search engine results page (SERP) includes the item identified by the computing system as being relevant to the query and a selectable button that indicates that content can be generated based upon the query. The computing system transmits the SERP to the client computing device, and upon receiving an indication that a user has selected the selectable button in the SERP, the computing system provides the query as input to a computer-implemented model that generates content based upon textual input. For instance, the computer-implemented model is a diffuser model that generates images, video, text, etc. based upon textual input (and optionally other input, such as an image, video, etc., such that the input is multi-modal). The computer-implemented model generates content based upon the query, and the computing system transmits the content to the client computing device for presentment to the user by way of the application.

In another example, upon receipt of the query, the computing system searches the computer-readable index for items that are relevant to the query and the computing system provides the query as input to the computer-implemented model. In such an example, the SERP includes both: 1) an item identified by the computing system as being relevant to the query; and 2) content generated by the computer-implemented model.

Further, the computing system can search the computer-readable index based upon the content generated by the computer-implemented model. More particularly, the computing system can transmit the content generated by the computer-implemented model to the client computing device for presentment to the user by way of the application. The client computing device receives an indication from the user that a search is to be performed based upon the content. More specifically, the content can have feature values, and the computing system can search the computer-readable index based upon the feature values. The computing system identifies items that are indexed in the computer-readable index based upon the feature values of the content generated by the computer-implemented model. Hence, the computing system can identify pre-existing items that are similar to the content that was generated (on-demand) based upon the query. The computing system transmits the identified items to the client computing device for presentment to the user by way of the application executing on the client computing device.

While the examples set forth above have referenced a SERP, it is emphasized that the technologies described herein are not limited to inclusion in search engines. Rather, the technologies describe herein can be used in connection with productivity applications (e.g., when a user is searching for content to include in a word processing document, a slideshow presentation, etc.), and the claims are not to be limited to search engines unless expressly recited in such claims.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of a computing system that can generate search results and dynamically create content based upon a query received from a client computing device.

FIG. 2 is a functional block diagram of a computing system that can generate search results based upon a query and transmit the query to a second computing system that can generate content based upon the query.

FIGS. 3-6 are graphical user interfaces (GUIs) of an application executing on a client computing device.

FIG. 7 is a flow diagram illustrating a methodology for returning a search result and generating content based upon a query.

FIG. 8 is a flow diagram illustrating a methodology for generating a search engine results page (SERP) that includes a selectable button corresponding to generating content based upon a query.

FIG. 9 is a flow diagram illustrating a methodology for generating content based upon: 1) a query; and 2) search history of a user indicating that content can be generated for the user.

FIG. 10 is a flow diagram illustrating a methodology for performing a search over a computer-readable index based upon content that was generated based upon a query.

FIG. 11 is a schematic of a computing system.

### DETAILED DESCRIPTION

Various technologies pertaining to searching for content and generating content based upon a query are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something and is not intended to indicate a preference.

Described herein are various technologies pertaining to searching for content and generating content based upon a query. With more particularity, a computing system receives a query from an application executing on a client computing device, where the query is set forth to the client computing device by a user thereof. In an example, the computing system executes a general-purpose search engine, and the user is providing the query to the search engine. Based upon the query, the computing system searches a computer-readable index of items, where the items may be webpages, images, videos, etc. Additionally, the computing system provides the query to a computer-implemented model that generates contents based upon textual input. In an example, the computer-implemented model is a diffuser model that generates images based upon input, where the input can be textual or multi-modal. The computer-implemented model generates content based upon the query (e.g., a prompt), and the computing system returns search results to the client computing device. In an example, the search results include an item identified in the search of the computer-readable index as well as the content generated by the computer-implemented model.

The query may be a relatively complex query that expresses an information retrieval intent that can be identified by the computing system; however, there may be few (or no) items indexed by the computing system that satisfy the information retrieval intent. An example query is “picture of a baseball player swinging a baseball bat at a soccer ball”. In this example, the query is well-formed (the information retrieval intent of user can be readily ascertained). An image that precisely matches the information retrieval intent of the user, however, may not be indexed by the computing system (or may not be readily located in an index of images based upon the textual query). Utilizing the technologies described herein, the information retrieval intent of the user who issued the query can be satisfied by providing the query to the computer-implemented model (as a prompt), which can generate the requested image based upon the query. Further, the computing system can receive an indication that the generated content is to be employed as a query (in a visual search). Accordingly, values for features of the generated content can be computed, where such values can be employed to search a computer readable index of items (images, videos, etc.). The computing system can search the computer readable index based upon the values for the features of the generated content and can identify and item in the computer readable index based upon such values. Put differently, the computing system can identify items indexed in the computer readable index based upon the content that was generated by the computer implemented model, where the identified items are similar to the generated content. Continuing with the example above, the computer implemented model can generate an image of a baseball player swinging a baseball bat at a soccer ball, and values for features of such generated image can be employed by the computing system to identify previously indexed images that are similar to such image. Thus, if the user were searching for a pre-existing image of a baseball player swinging a bat at a soccer ball, the computing system can identify such image based upon the image generated by the computer implemented model.

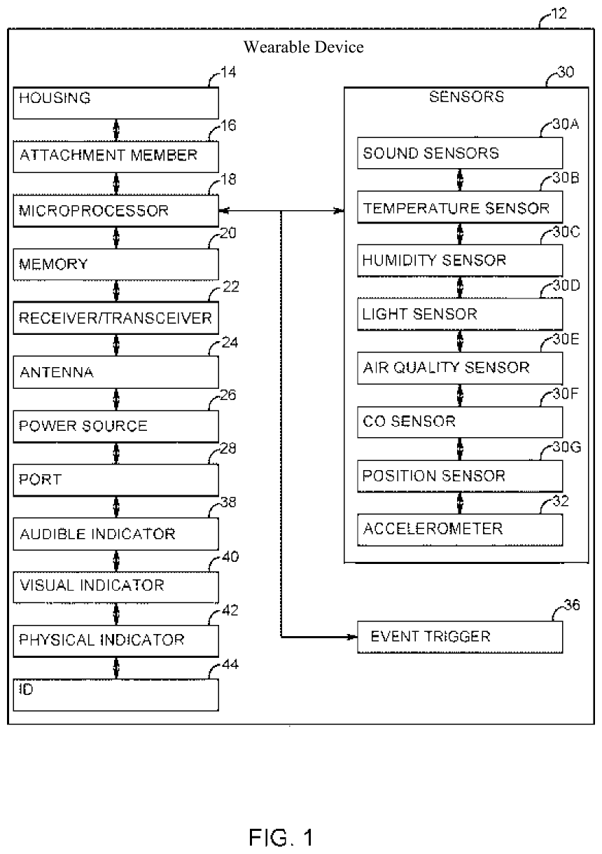

Referring now to FIG. 1, a functional block diagram of a computing environment 100 is illustrated. The computing environment 100 includes a computing system 102 and a client computing device 104 that is in communication with the computing system 102 by way of a network 106. The client computing device 104 is operated by a user 108. The client computing device 104 may be any suitable type of client computing device, including but not limited to a desktop computing device, a laptop computing device, a tablet computing device, a mobile telephone, a smart watch, augmented or virtual reality headgear, etc. The client computing device 104 executes an application that can receive a query set forth by the user 108 and can transmit the query to the computing system 102 by way of the network 106. In an example, the application can be a web browser that has loaded a webpage of a general-purpose search engine, where the webpage includes a control for receiving a query from the user 108 (where the control can be a text entry field, a button that initiates a microphone on the client computing device 104, etc.). In another example, the application executed by the client computing device 104 can be a productivity application, such as a word processing application, a spreadsheet application, a slideshow presentation application, an e-mail application, a unified communications application, etc. In still yet another example, the application can be an instant messaging application, a chat application, or other suitable communications application.

The computing system 102 includes a processor 110 and memory 112, where the memory 112 has instructions loaded therein that are executed by the processor 110. The computing system 102 also includes a data store 114, where the data store 114 comprises a document index 116, an image index 118, and search history data 120. While not shown, the data store 114 may also include a video index or an index of another type of item. The document index 116 is a computer-readable index that indexes documents by terms that pertain to such documents. For instance, the documents are webpages that are indexed by terms included in the webpages, indexed by terms in metadata assigned to the webpages, and so forth. The image index 118 is a computer-readable index that indexes images by terms and/or feature values that pertain to the images. The search history data 120 can identify numbers of searches performed by users of the computing system 102, numbers of days that users performed searches through use of the computing system 102, etc.

The memory 112 of the computing system 102 includes a search system 122 that searches the document index 116, the image index 118, and/or other suitable computer-readable indices (such as a video index) based upon queries received by the computing system 102. The search system 122 additionally generates contents based upon queries received by the computing system 102, as will be described in greater detail below. The search system 122 returns search results to client computing devices that transmit queries to the computing system 102, where the search results include items identified based upon searches of indices in the data store 114 and/or content generated based upon the queries.

The search system 122 optionally includes an authorizer module 124 that ascertains whether content can be generated on behalf of the user. Generating content based upon textual or multi-modal input is computationally expensive, and the authorizer module 124 can restrict content generation to users who are relatively frequent users of the search system 122. Accordingly, prior to the search system 122 generating content based upon a query received from a client computing device operated by the user, the authorizer module 124 can access the search history data 120 and grant or deny a request to generate content based upon information in the search history data 120 assigned to the user. When the authorizer module 124 determines that the user has set forth a number of queries to the search system 122 over a window of time that is greater than a threshold, the authorizer module 124 can authorize generation of content based upon a query received from a client computing device operated by the user. In another example, when the authorizer module 124 determines that the user has set forth queries to the search system 122 during a number of days that is above a predefined threshold, the authorizer module 124 can authorize generation of content based upon a query received from the client computing device operated by the user.

The computing system 102 further optionally includes a query classifier 126 that assigns classification labels to queries received by the computing system 102, where a classification label assigned to a query by the query classifier 126 indicates whether content is to be (dynamically) generated based upon the query. The query classifier 126 can be a binary classifier, where a first label that is assignable to a query by the query classifier 126 indicates that content is not to be generated based upon the query, while a second label that is assignable to the query by the query classifier 126 indicates that content is to be generated based upon the query. The query classifier 126 can be trained based upon queries having labels assigned thereto, where the labels indicate whether or not content is to be generated based upon the queries. Some queries are well-suited for generating content, such as relatively long and detailed queries like “video of a fish jumping out of the water while holding a banjo”. Other queries are not well-suited for generating content, such as a query requesting a fact or a query pertaining to a particular webpage, such as “how tall was George Washington” or “US Congress webpage”. The query classifier 126 is trained to distinguish between queries that are well-suited for generating content and queries that are not well-suited for generating content.

The search system 122 comprises an index search module 128 that searches the document index 116 and/or the image index 118 (or other suitable computer-readable index) based upon queries received from client computing devices. The index search module 128 can identify items from the indices 116-118 based upon the queries and can further rank identified items to form ranked lists of items.

The search system 122 further comprises a content generator module 130 that generates contents based upon queries received by the search system 122. With more particularity, the content generator module 130 includes a computer-implemented model that generates contents based upon textual input or multi-modal input. In an example, the computer-implemented model is a diffuser model. The computer-implemented model, in one example, generates images based upon prompts. The computer-implemented model, in another example, generates videos based upon prompts. In still yet another example, the computer-implemented model generates text and/or audio based upon prompts.

The search system 122 further optionally includes a feature identifier module 132 that computes values for features of contents generated by the content generator module 130. For example, images in the image index 118 can be indexed by values of features of such images. When the content generator module 130 generates an image based upon textual input, the feature identifier module 132 can compute values for the features of such image. Values of features of images can be indicative of colors existent in the images, location of certain features in the images, and so forth.

The search system 122 also includes a suggestion module 134 that generates query suggestions based upon one or more of: 1) contents generated by the content generator module 130; 2) search results identified by the index search module 128; 3) previous queries issued to the search system 122, and so forth. In an example, queries suggested by the suggestion module 134 can be queries that are well-suited for use by the content generator module 130 to generate content.

The search system 122 also includes a visual search module 136 that can perform a visual search, where the visual search module 136 uses an image generated by the content generator module 130 as a basis for searching the image index 118. As noted above, the feature identifier module 132 can compute values for features of an image generated by the content generator module 130. The visual search module 136 can search the image index 118 based upon the values of such features and can identify images that are similar to the image generated by the content generator module 130.

The search system 122 also includes a supplemental content module 138 that can identify supplemental content based upon at least one of a query received by the search system 122, a search result identified by the index search module 128, or a value of a feature of content generated by the content generator module 130. In an example, the supplemental content is an electronic advertisement that is presented together with search results.

An example of operation of the search system 122 is now set forth. The search system 122 receives a query set forth by the user 108 of the client computing device 104, where the query is received by way of the application executing on the client computing device 104. Optionally, the authorizer module 124 (prior to or in response to receipt of the query) searches the search history data 120 based upon an identifier of the user 108 to ascertain whether the user is authorized to have content generated on their behalf. When the authorizer module 124 determines that content is not to be created on behalf of the user 108, the search system 122 does not provide the query to the content generator module 130.

When the authorizer module 124 determines that content can be created for the user 108, the search system 122 optionally provides the query to the query classifier 126. The query classifier 126 assigns a classification label to the query, where the classification label indicates whether or not the query is to be provided to the content generator module 130. When the classification label indicates that the query is not to be provided to the content generator module 130, the search system 122 does not provide the query to the content generator module 130.

Regardless of the output of the authorizer module 124 and the output of the query classifier module 126, the index search module 128 searches a computer-readable index (the document index 116, the image index 118, or other suitable index in the data store 114) based upon the query. The index search module 128 can identify an item indexed in the computer-readable index based upon the query (e.g., the index search module 128 identifies the item as being relevant to the query).

When the authorizer module 124 determines that content can be created for the user 108, and further when the query classifier 126 assigns a classification label to the query that indicates that the query is to be provided to the content generator module 130, the search system 122 provides the query to the content generator module 130. The content generator module 130 generates content based upon the query. In an example, when the query is “baseball player hitting a soccer ball with a baseball bat”, the content generator module 130 generates an image that includes a baseball player hitting a soccer ball with a baseball bat.

The search system 122 can return search results to the client computing device 104 for presentment by way of a graphical user interface of the application executing on the client computing device 104, where the search results include at least one of the item identified as being relevant to the query by the index search module 128 or the content generated by the content generator module 130 based upon the query. For example, the search system 122 may be included in a general-purpose search engine, and the search results can be included in a search engine results page (SERP) that is provided to the client computing device 104 for presentment to the user 108 by way of the application executing on the client computing device 104.

As mentioned previously, the content generator module 130 may utilize a significant amount of computing resources when generating the content based upon the query. Accordingly, it may take some amount of time for the content generator module 130 to generate the content (e.g., 1-5 seconds). The search system 122 can generate animations for presenting the content generated by the content generator module 130 together with the item identified by the index search module 128 based upon the query. For example, the search system 122 constructs a SERP to include a region for displaying content generated by the content generator module 130, where generated content “fades in” over time (such that the user 108 does not see a blank portion of a SERP until generation of the content is completed). In another example, the suggestion module 134 generates query suggestions based upon the query received from the client computing device 104, the item identified by the index search module 128 as being relevant to the query, previous query submitted by the user 108 or other users of these search system 122, etc. Query suggestions generated by the suggestion module 134 can be presented in the GUI of the application executing on the client computing device 104 until the content generator module 130 completes generation of the content. Thereafter, the search system 122 can update the information presented to the user 108 to include the content generated by the content generator module 130.

The feature identifier module 132 computes values for features of the content generated by the content generator module 130, where the values for the features can reflect items depicted in the content, named entities in the content, locations of items in the content, gradients in the content, and so forth. When the content is an image, the feature identifier module 132 can update the image index 118 to index the image generated by the content generator module 130 by the values of the features computed by the feature identifier module 132. Similar operations can be performed when the content is a video, text, multi-modal, etc.

In some cases, the user 108 may wish to employ content generated by the content generator module 130 to locate an item included in one of the indices 116-118 stored in the data store 114. Thus, the search system 122 can receive a message from the client computing device 104 that indicates that the search system 122 is to search one or more of the indices 116-118 based upon the content generated by the content generator module 130. This may occur when the user 108 desires to find pre-existing content that is similar to the content generated by the content generator module 130. Upon receipt of such message, the visual search module 136, for example, can search the image index 118 based upon the values of the features of the content generated by the content generator module 130. The visual search module 136 can identify an image indexed in the image index 118 based upon the search of such index 118, and the search system 122 can return the identified image to the client computing device 104 as an updated search result. Hence, again, the search system 122 can employ the content generated by the content generator module 130 in connection with searching for content that is similar to the content generated by the content generator module 130.

The supplemental content module 138 can identify supplemental content, such as an electronic advertisement, based upon the query received by the search system 122, the item identified as being relevant to the query by the index search module 128, a value of a feature of the content generated by the content generator module 130, and so forth.

In summary, then, the search system 122 can search for existing (indexed) items based upon the query received from the client computing device 104 and can additionally (dynamically) generate content based upon the query received from the client computing device 104. This may be particularly advantageous in scenarios where the information retrieval intent is clearly expressed in the query but an item that closely aligns with such intent is not indexed in a computer readable index that is accessible to the search system 122. The technologies described herein pertain to improvements over conventional search systems, which are limited to searching for pre-existing (indexed) items.

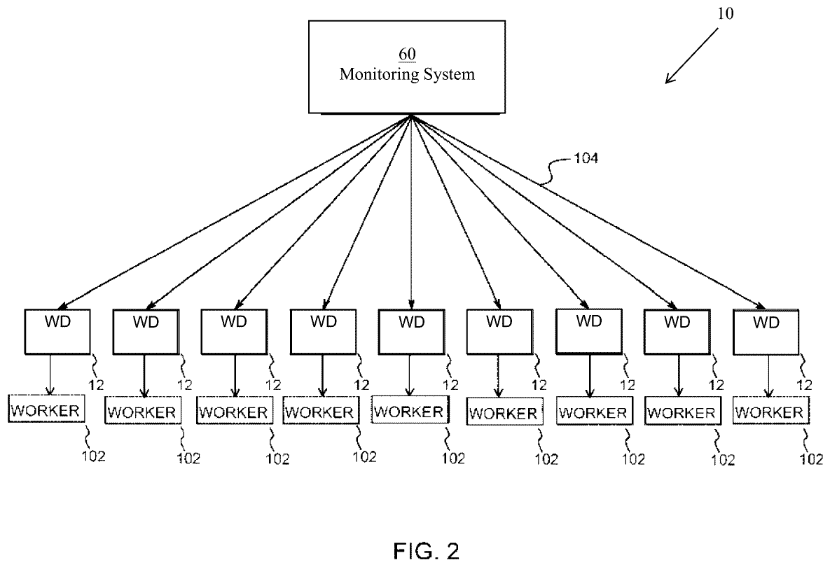

Now referring to FIG. 2, a computing environment 200 is depicted. The computing environment 200 includes the computing system 102 and the client computing device 104. The computing environment 200 additionally includes a second computing system 202, where the second computing system 202 includes a processor 204 and memory 206. The memory 206 stores instructions that are executed by the processor 204. In the computing environment 200, the memory 206 includes the content generator module 130.

The modules 124-138 operate as described above with respect to FIG. 1. In the computing environment 200, however, rather than the search system 122 including the content generator module 130, the second computing system 202 includes the content generator module 130. Accordingly, when the search system 122 receives a query from the client computing device 104, the computing system 102 can transmit the query to the second computing system 202 (when the content generator module 130 is to generate content based upon the query). In another embodiment, upon receiving the query, the computing system 102 can instruct the client computing device 104 to transmit the query to the second computing system 202. Upon receiving such instructions, the client computing device 104 can transmit the query to the second computing system 202.

The content generator module 130 generates the content based upon the query and transmits the content to one of the computing system 102 or the client computing device 104. When the second computing system 202 transmits the content to the computing system 102, the search system 122 includes the generated content in search results and transmits the search results to the client computing device 104. When the second computing system 202 transmits the generated content to the client computing device 104, the application executing on the client computing device 104 can incorporate the content into a GUI of the application. FIG. 2 is set forth to illustrate that separate computing systems can perform operations of search and content generation, respectively. The client computing device 104 in the environment 200 receives both pre-existing (indexed content) identified based upon the query and content that is dynamically generated based upon the query.

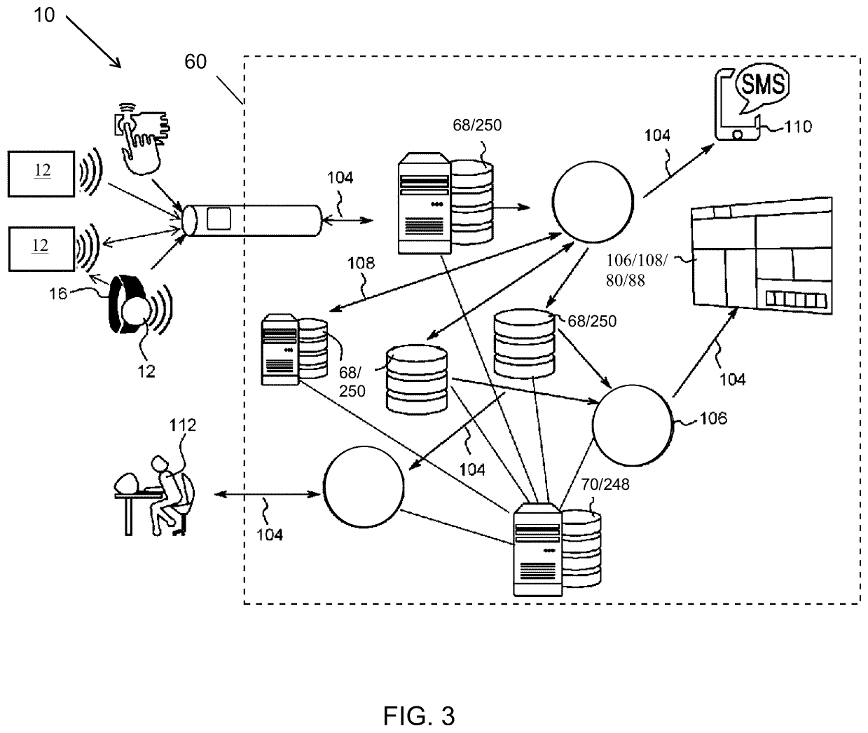

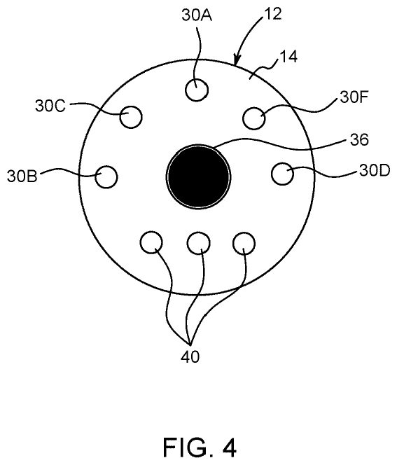

FIGS. 3-6 depict examples of GUIs of a search engine that can be presented on the client computing device 104. While the GUIs depict certain items and arrangement of items, it is to be understood that the technologies described herein are not limited to the items or arrangement of items. For example, some GUIs depict images returned as search results; it is to be understood that the search results may be video search results, multi-modal search results, or the like. Further, while one or more of the GUIs illustrates content generated based upon textual input as being images, such content (as noted above) can be or include text, video, images, some combination thereof, and so forth.

Now referring solely to FIG. 3, a schematic illustrating a GUI 300 corresponding to a search engine is illustrated. The GUI 300 includes a text entry field 302 that receives a query set forth by the user 108. In this example, the index search module 128 has identified M images 304-306 and N webpages 308-310 as being relevant to the query. Further, the supplement content module 138 has identified Q electronic advertisements 312-314, and the suggestion module 134 has identified P query suggestions 316-318 based upon, for example, the query set forth in the text entry field 302.

In the example illustrated in FIG. 3, the query classifier 126 has assigned a classification label to the query that indicates that the content generator module 130 can generate content based upon such query. Rather than allocating computing resources without receipt of a user instruction to generate content, the search system 122 causes a selectable button 320 to be included in the GUI 300. The selectable button 320 indicates to the user 108 that when the selectable button 320 is selected, content will be dynamically generated based upon the query.

FIG. 4 is a schematic of a GUI 400 that can be generated by the search system 122 upon the search system 122 receiving an indication that the selectable button 320 has been selected by the user 108. The search system 122, upon receipt of an indication that the user 108 has selected the selectable button 320, provides the query to the content generator module 130. The content generator module 130 generates content based upon the query, and the search system 122 returns the generated content for presentment to the user 108 by way of the application executing on the client computing device 104. As illustrated in FIG. 4, the GUI 400 includes created content 402, which is the content generated by the content generator module 130. Such content can be an image, video, text, etc. The graphical user interface 400 may further include a selectable hyperlink 404. The selectable hyperlink 404 indicates to the user 108 then a search can be conducted over one or more computer-readable indices based upon the created content 402 depicted in the graphical user interface 400.

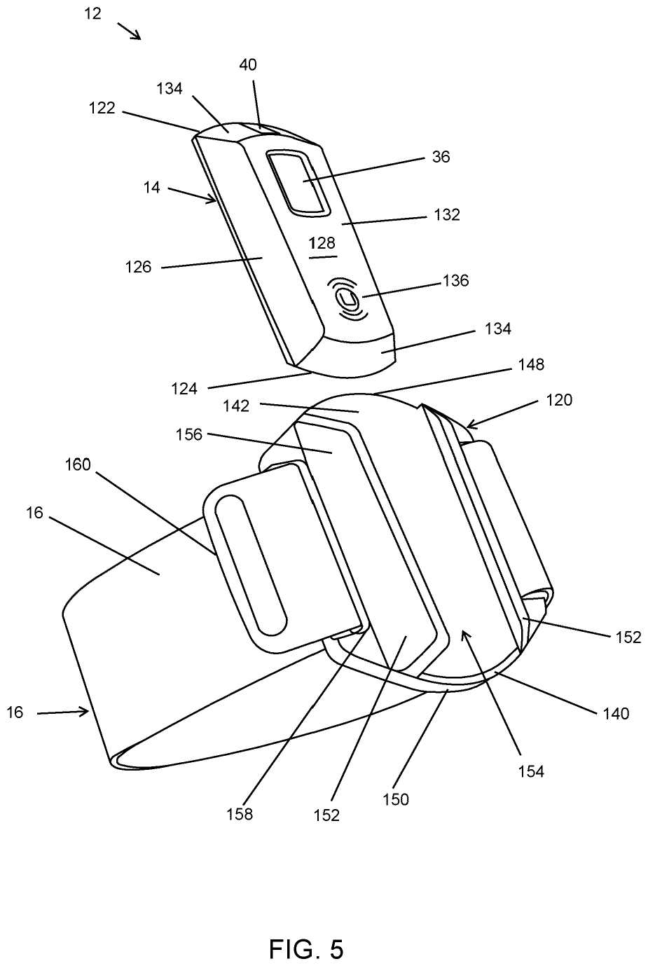

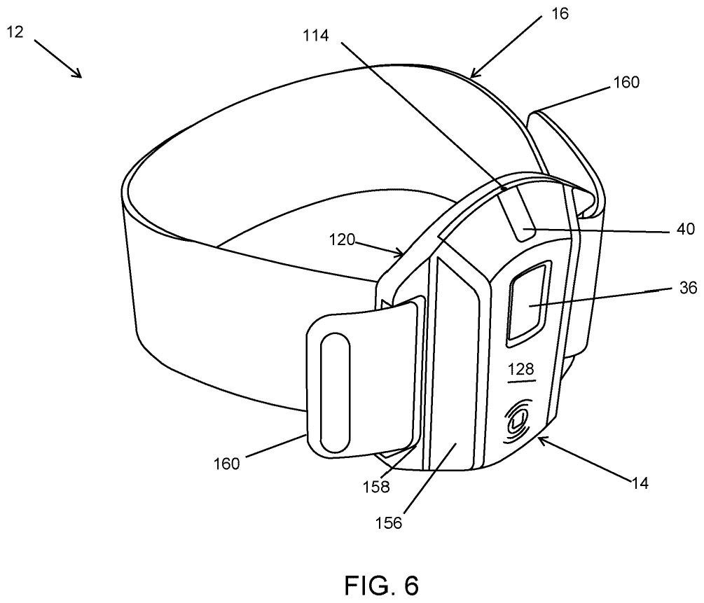

FIG. 5 is a schematic of a graphical user interface 500 where the search system 122 returns both items identified in the indices 116-118 and the created content 402 to the client computing device 104. In other words, in contrast to the GUI 300 shown in FIG. 3, the content generator module 130 generates the created content 402 without receipt of an explicit instruction from the user 108 to create such content.

Referring now to FIG. 6, a schematic of another graphical user interface 600 of the application executing on the client computing device 104 is presented. The visual search module 136 receives an indication that the user 108 has selected the hyperlink 404 and searches at least one computer-readable index based upon values for features of the created content 402. The graphical user interface 600 includes a field 602 where updated search results are presented, where the updated search results can include images, video, web pages, or the like.

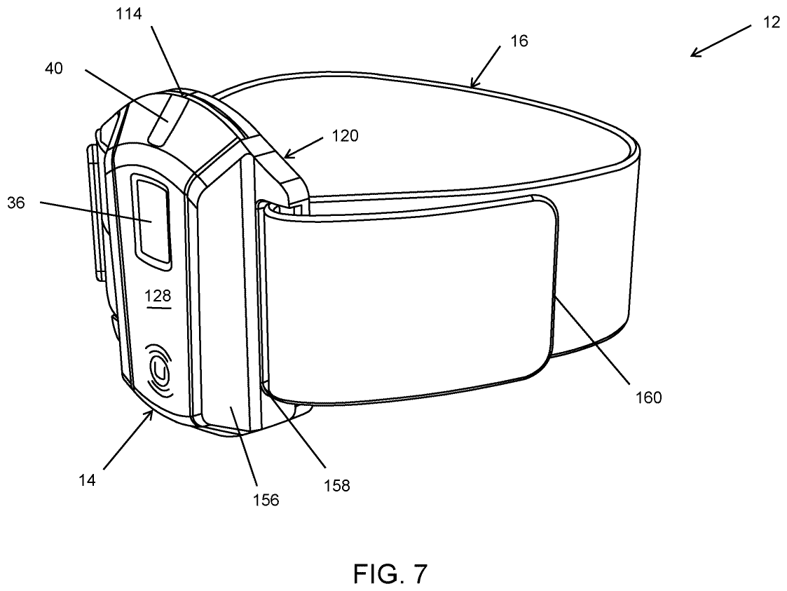

FIGS. 7-10 illustrate methodologies relating to provision of search results based upon a query, where the search results include pre-existing items identified based upon the query and content dynamically generated based upon the query. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring now solely to FIG. 7, a methodology 700 for returning an indexed search result and generated content to a client computing device based upon a query received from the client computing device is illustrated. The methodology 700 starts at 702, and at 704 a query is received from a client computing device. At 706, a computer-readable index is searched based upon the received query. As noted above, the computer-readable index can index webpages, images, videos, and/or the like.

AT 708, a search result is identified from the computer-readable index based upon the search. At 710, content is generated (dynamically) based upon the query, where the content is generated by a computer-implemented model. For instance, the computer-implemented model is a diffuser model. At 712, the search result identified at 708 and the content generated at 710 are returned to the client computing device. The methodology 700 completes at 714.

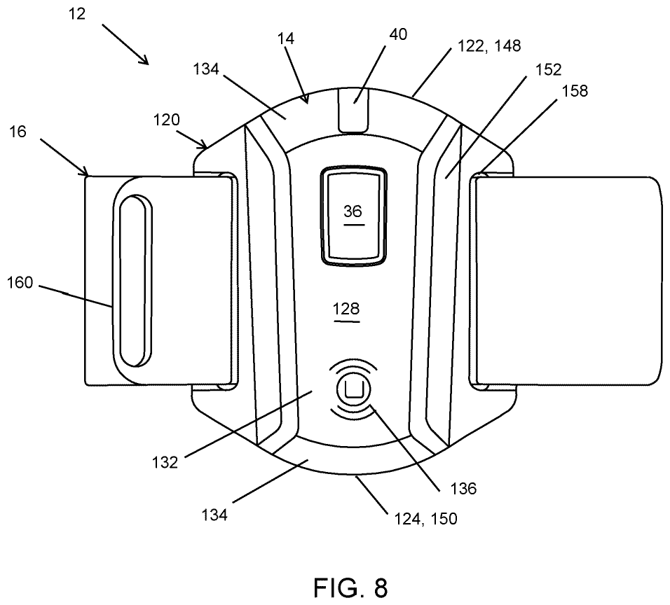

Now referring to FIG. 8, a methodology 800 for returning search results identified based upon a query and content generated based upon the query is illustrated. The methodology 800 starts at 802, and at 804 a query is received from a client computing device. At 806, a computer-readable index is searched based upon the received query. At 808, a search result is identified based upon the received query.

At 810, a determination is made as to whether the query is well-suited for provision to a computer-implemented model that generates content based upon textual input. When it is determined at 810 that the query is not well-suited for provision to the computer-implemented model, the methodology 800 proceeds to 812 and the search result is returned to the client computing device.

When it is determined at 810 that the query is well-suited for provision to the computer-implemented model, the methodology 800 proceeds to 814, where the search result and a selectable button are returned to the client computing device. Put differently, the search result is returned to the client computing device and a selectable button is caused to be presented on a display of the client computing device. The selectable button notifies a user who issued the query that selection of such button will result in content being generated based upon the query.

At 816, a determination is made as to whether the selectable button has been selected by the user. When it is determined at 816 that the selectable button has been selected, the methodology 800 proceeds to 818, where the query is provided to the computer-implemented model that generates content based upon textual input. At 820, generated content is obtained from the computer-implemented model, and at 822 the generated content is returned to the client computing device.

The methodology 800 completes at 824 upon the search result being returned to the client computing device at 812, upon a determination being made at 816 that the selectable button has not been selected, or upon return of the generated content to the client computing device at 822.

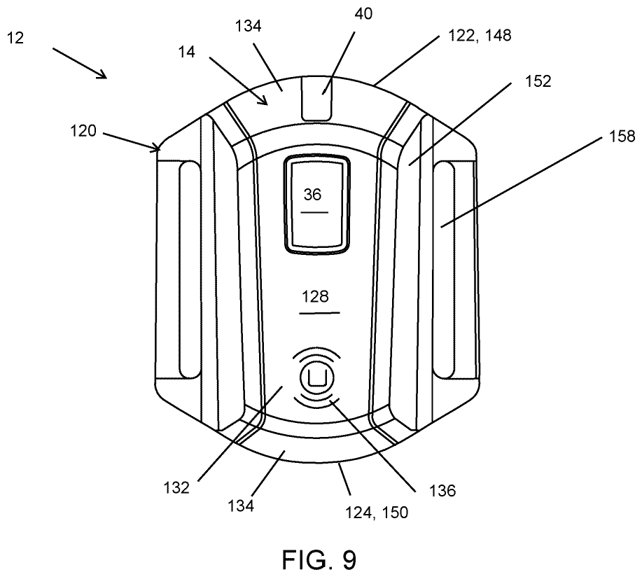

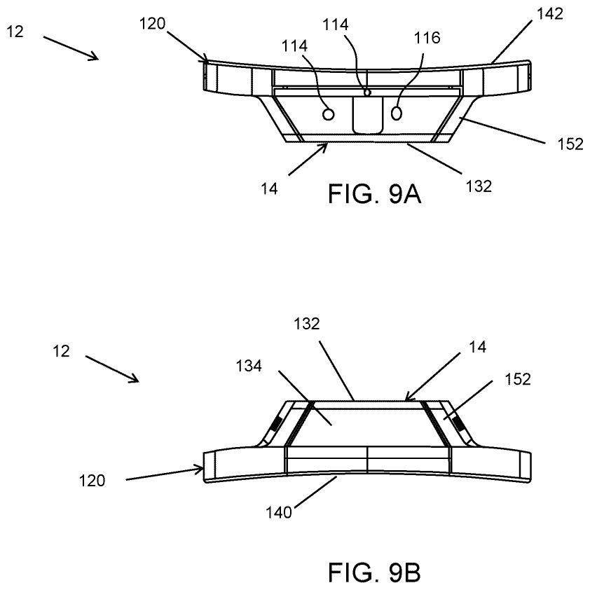

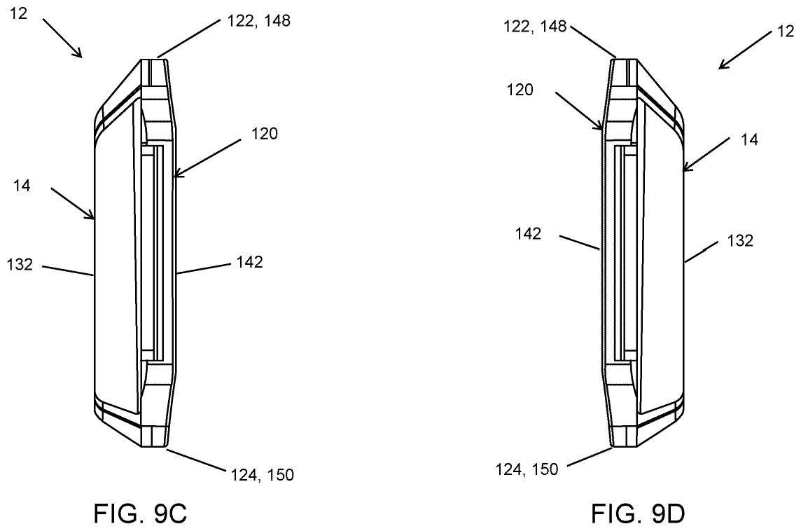

FIG. 9 illustrates a methodology 900 for returning a search result indexed in a computer readable index based upon a query and returning dynamically generated content based upon the query. The methodology 900 starts at 902, and at 904 a query is received from a client computing device. At 906, a computer-readable index is searched based upon the received query, and at 908 a search result is identified based upon the query.

At 910, a determination is made as to whether the query is well-suited for provision to a computer-implemented model that dynamically generates content based upon textual input. When it is determined at 910 that the query is not well-suited for provision to the computer-implemented model, the methodology 900 proceeds to 912, where the search result identified at 908 is returned to the client computing device. When it is determined at 910 that the query is well-suited for provision to the computer-implemented model, search history for the issuer of the query is accessed at 914. At 916, a determination is made as to whether content is to be generated based upon the search history for the issuer of the query. When it is determined that content is to be generated, the methodology 900 proceeds to 918, where the query is provided to a computer-implemented model that generates content based upon textual input. At 920, the generated content is obtained from the computer-implemented model, and at 922 the generated content and the search result identified at 908 are returned to the client computing device. The methodology 900 completes at 924 upon a determination at 910 that the query is not well-suited for provision to the computer-implemented model, upon a determination at 916 that content is not to be generated based upon the search history for the issuer of the query, or a upon the generated a content and search result being returned to the client computing device at 922.

While the methodology 900 illustrates the determination 910 occurring prior to the determination 916, it is to be understood that determination 916 may occur prior to the determination 910.

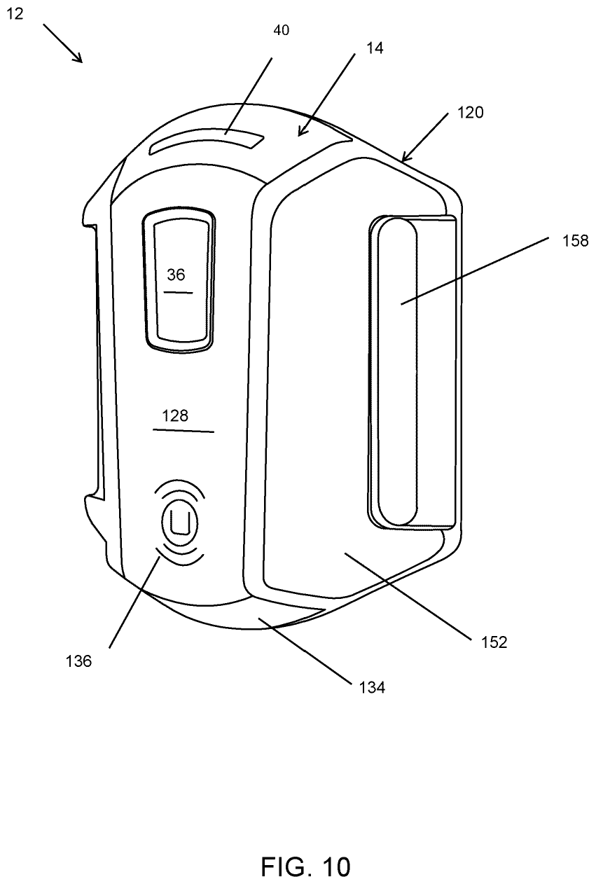

With reference now to FIG. 10, a methodology 1000 for performing a search based upon generated content is illustrated. The methodology 1000 starts at 1002, and at 1004 a query is received from a client computing device. At 1006, a determination is made that the query is usable by a computer-implemented model to generate content (dynamically). At 1008, content is generated based upon the query, where the content is generated by a computer-implemented model (e.g., a diffuser model).

At 1010, values for features of the content generated by the computer implemented model are computed. At 1012, a request to use the content as a query is received from the client computing device. At 1014, a computer-readable index of items is searched based upon the values of the features of the content computed at 1010. At 1016, an item is identified based upon the search, and at 1018 the item is returned to the client computing device. The methodology 1000 completes at 1020.

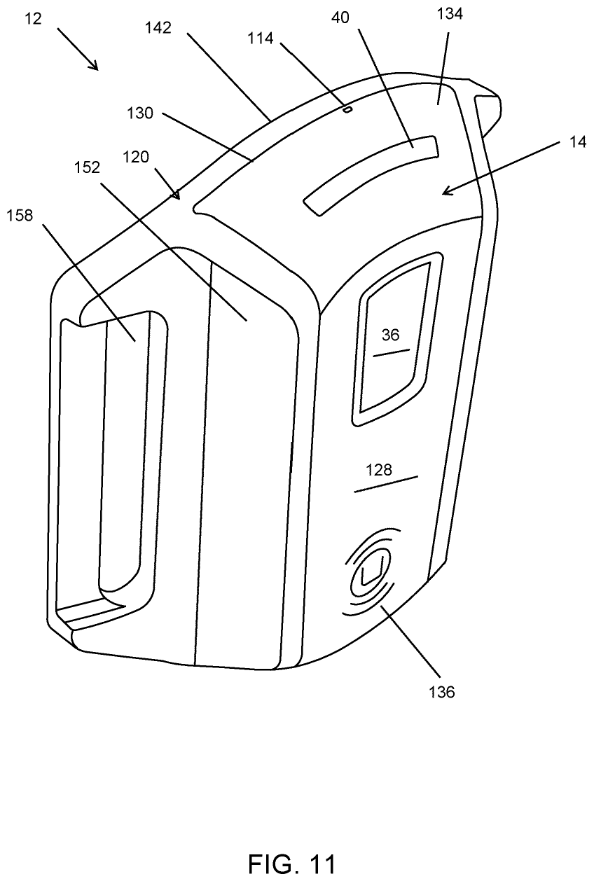

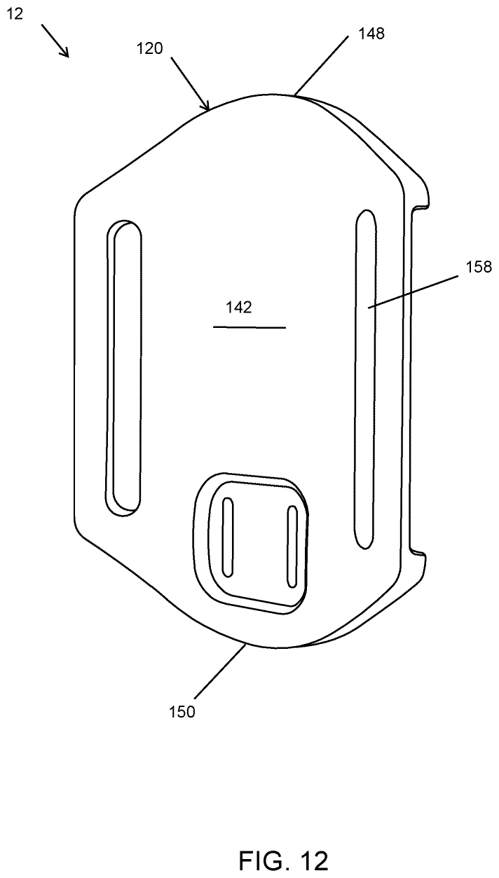

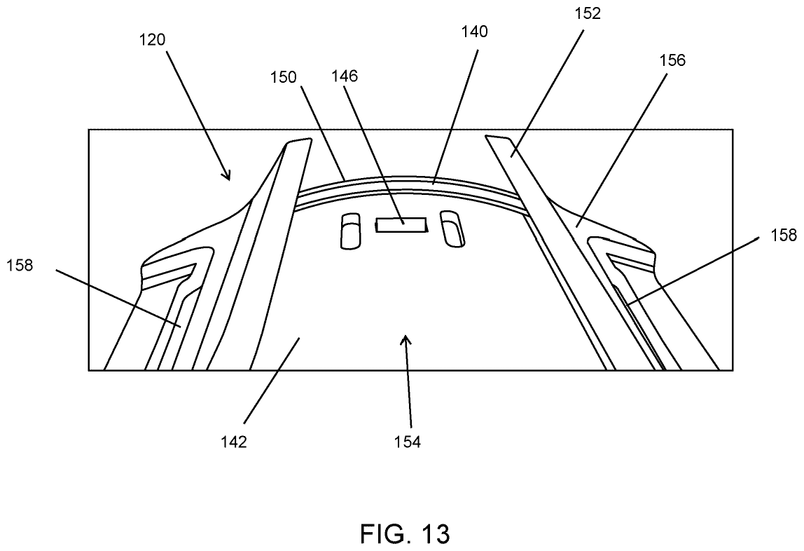

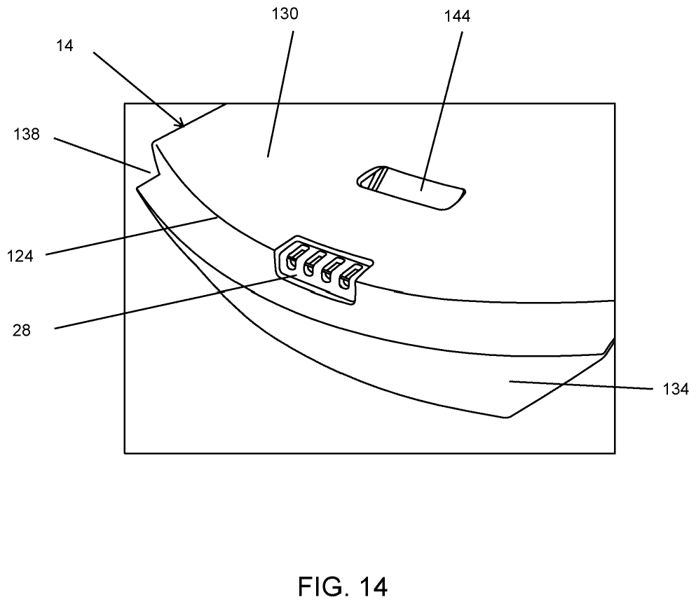

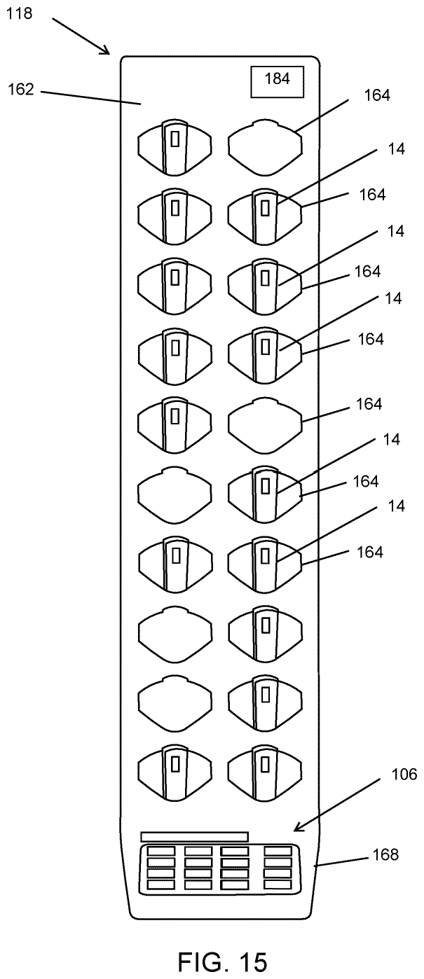

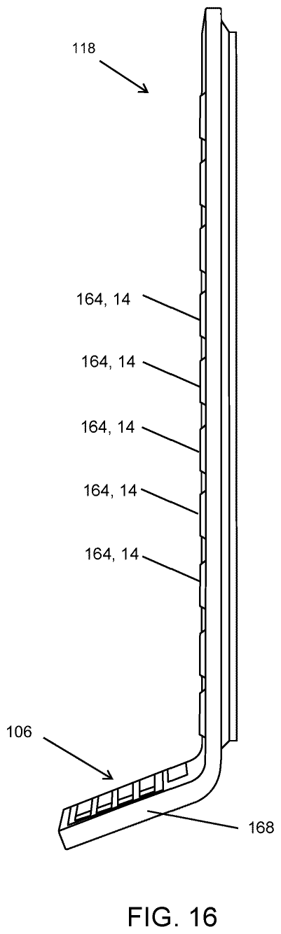

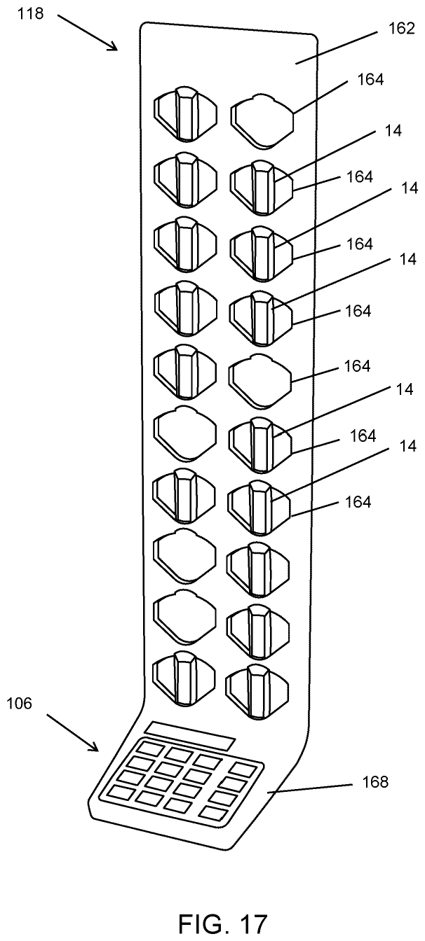

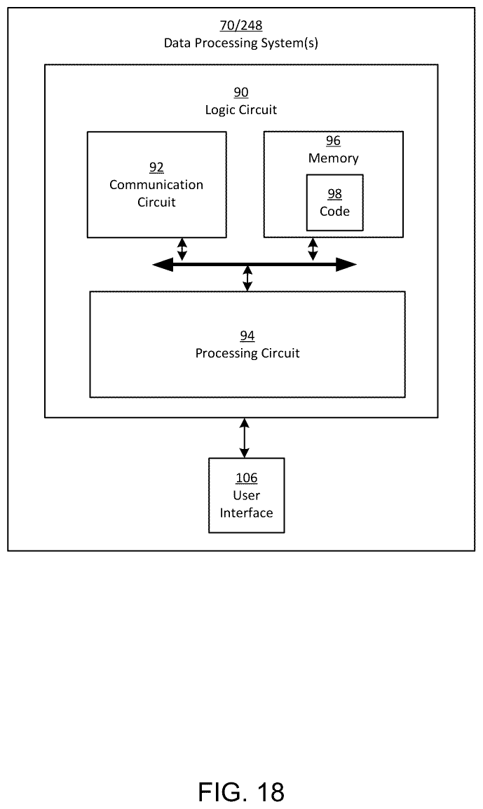

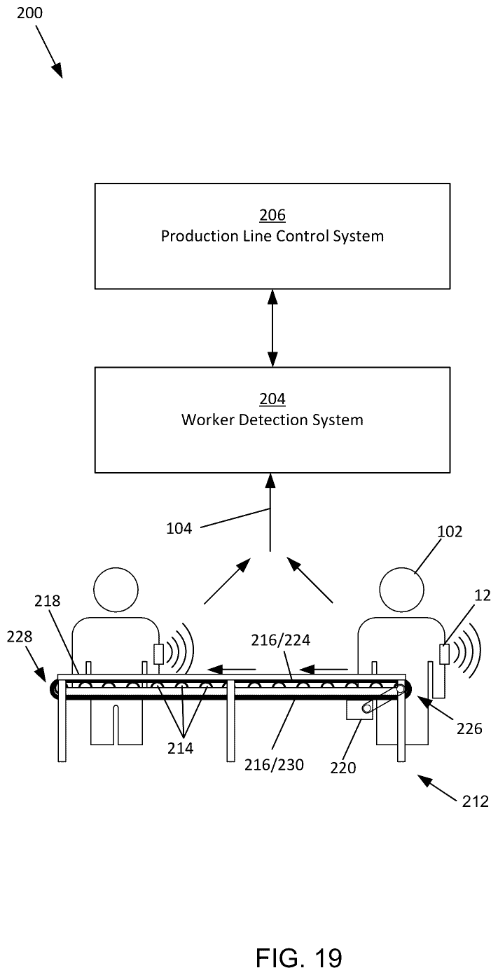

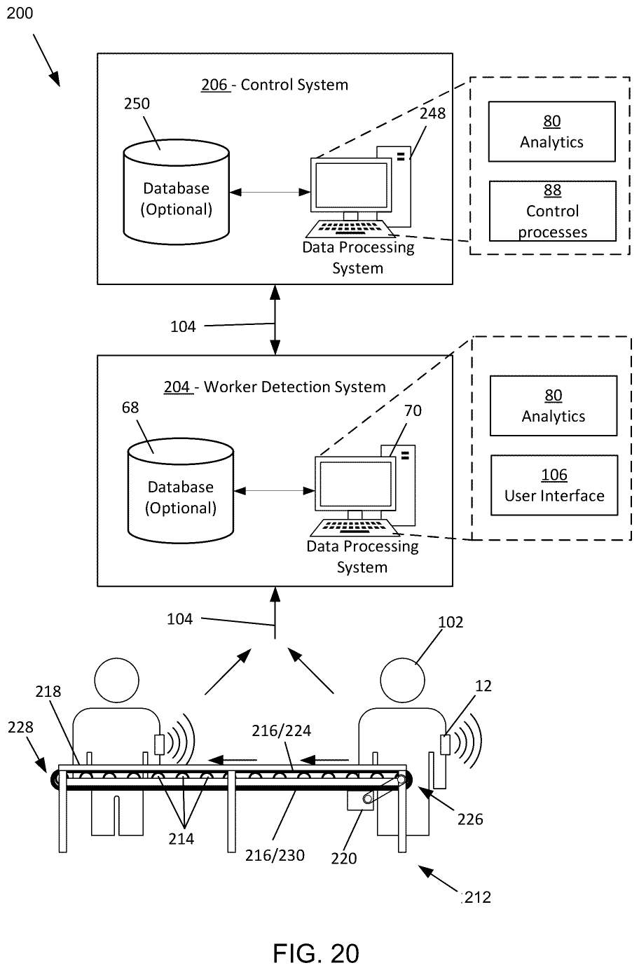

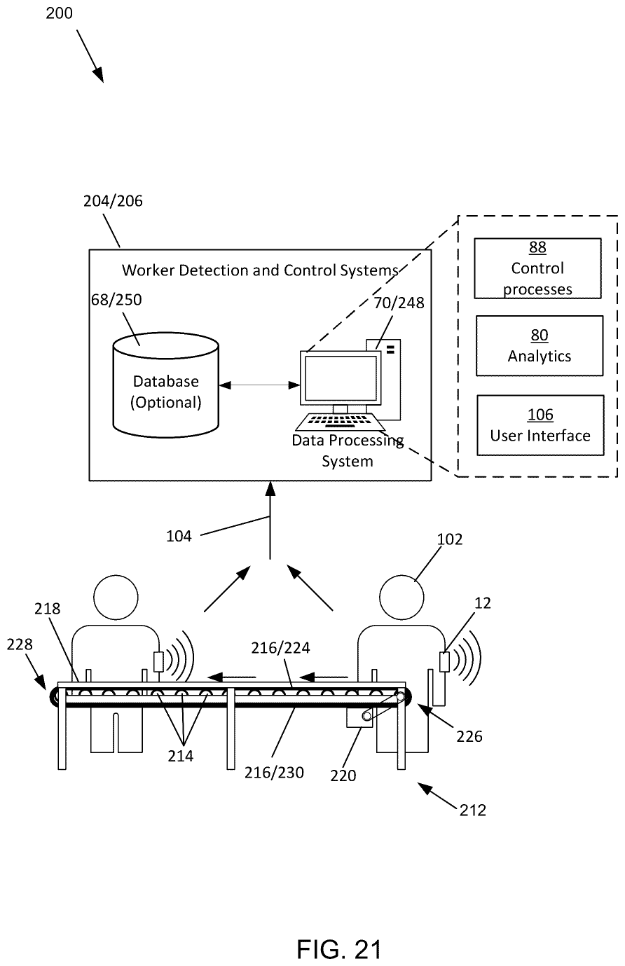

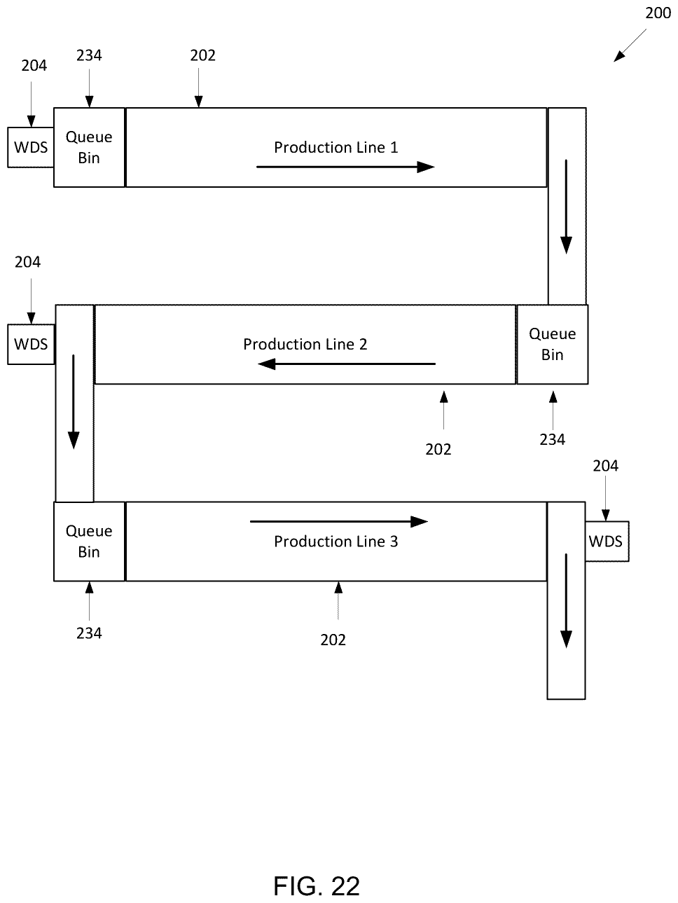

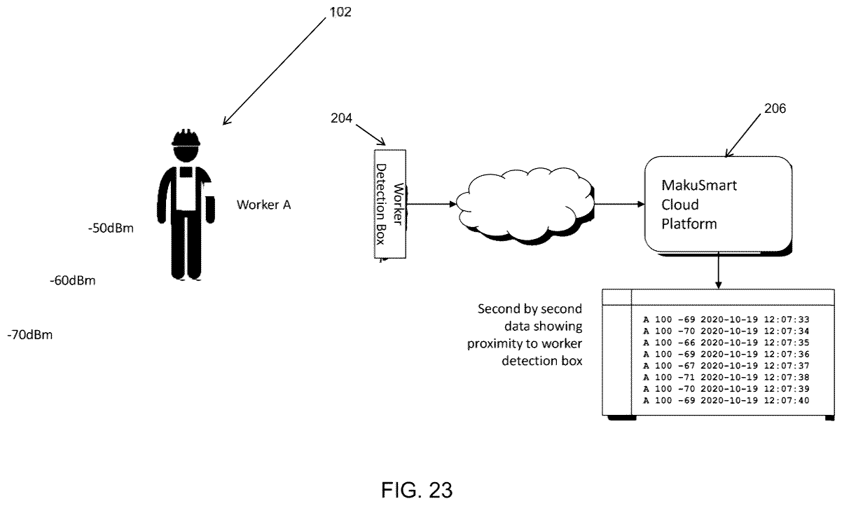

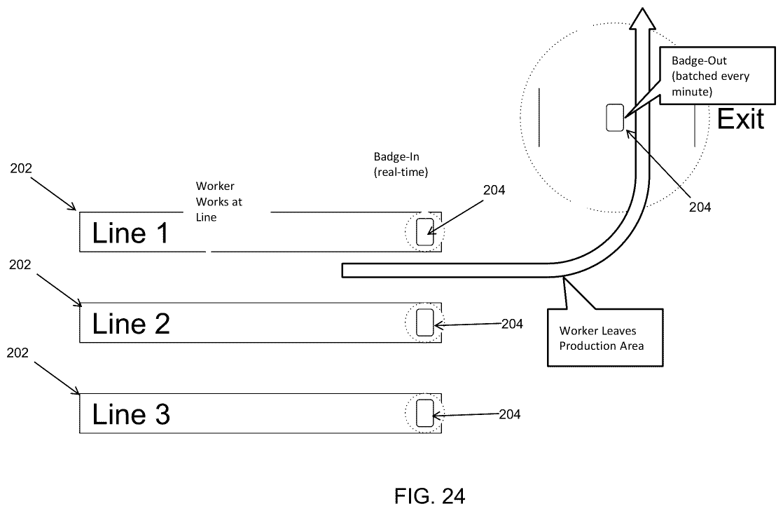

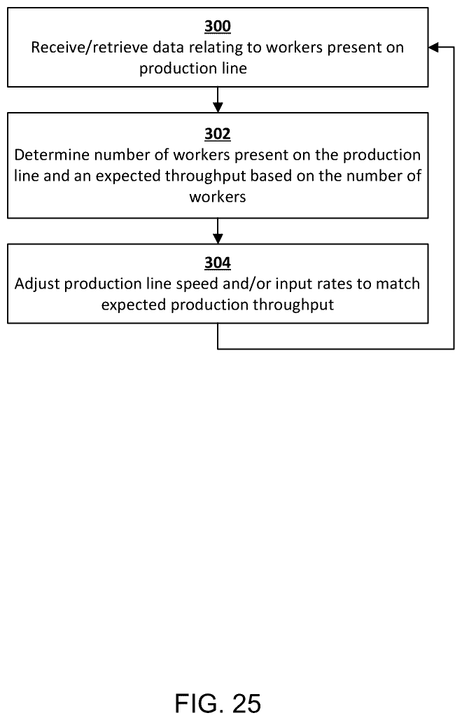

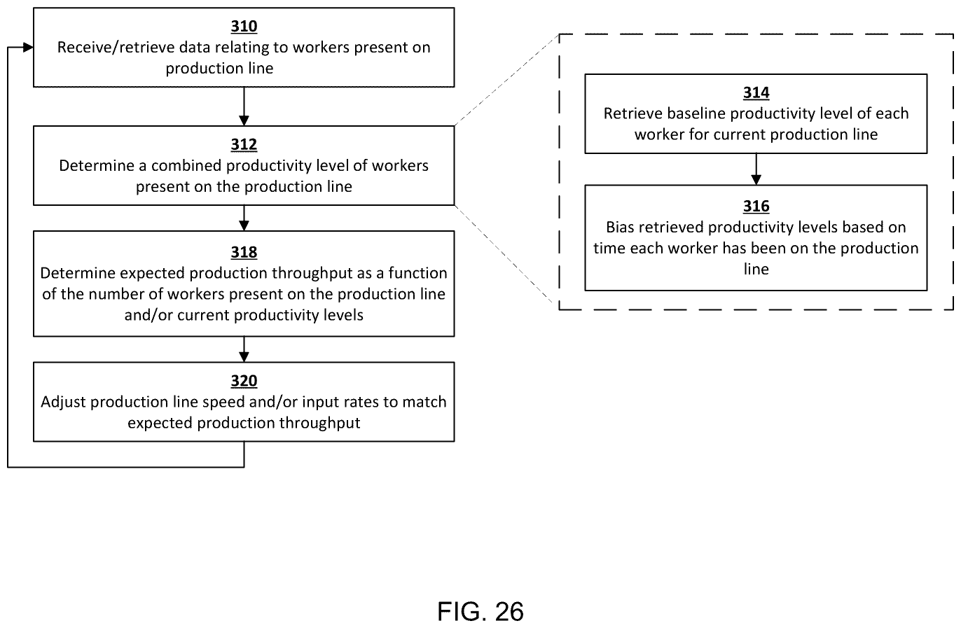

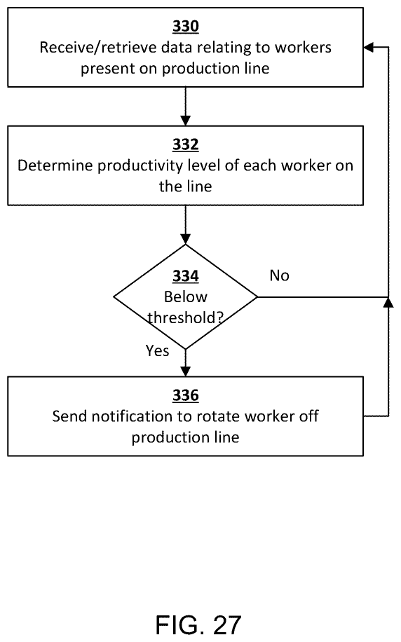

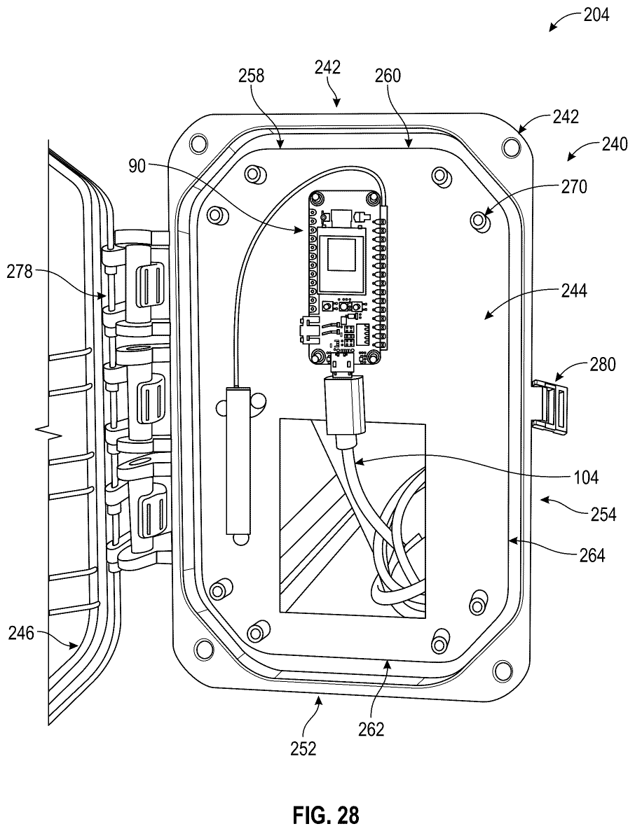

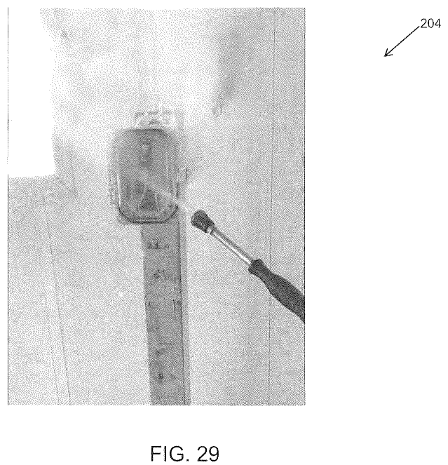

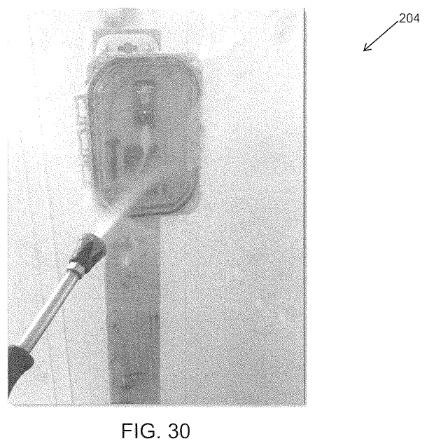

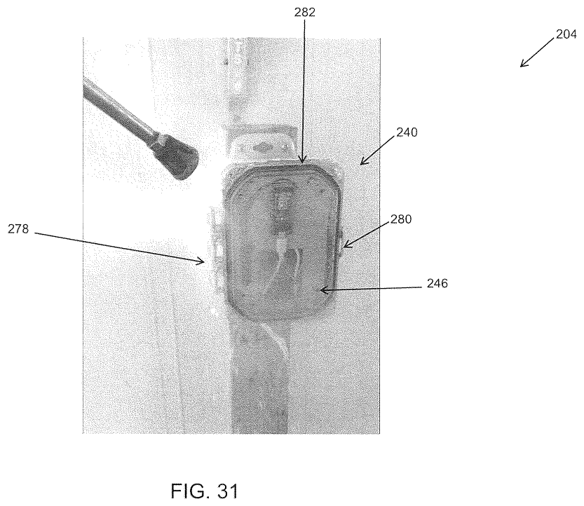

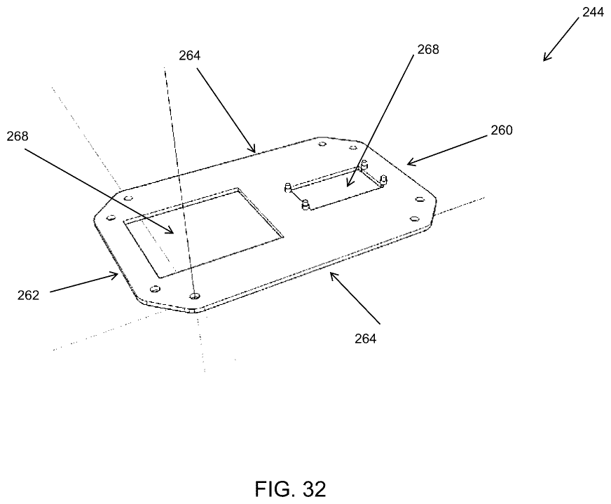

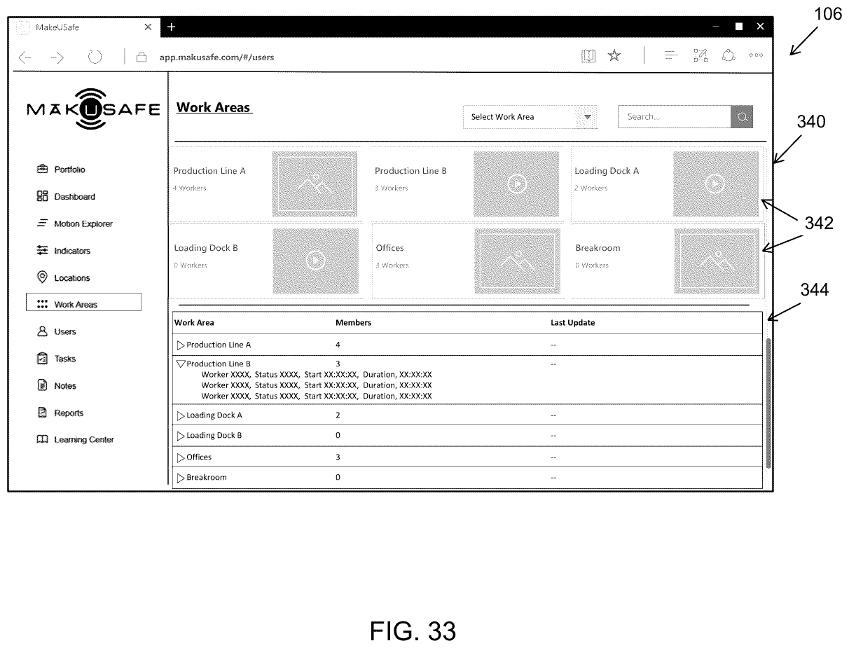

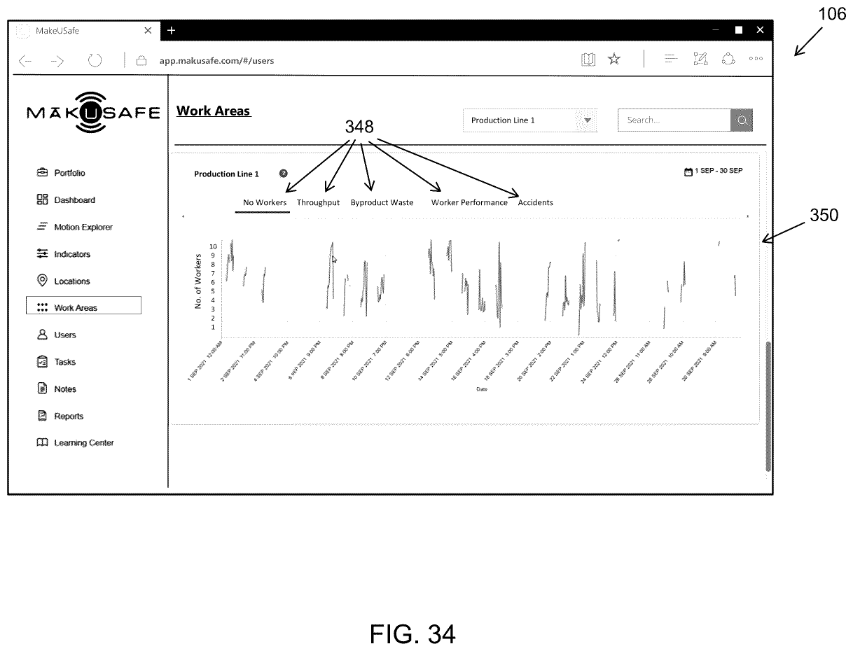

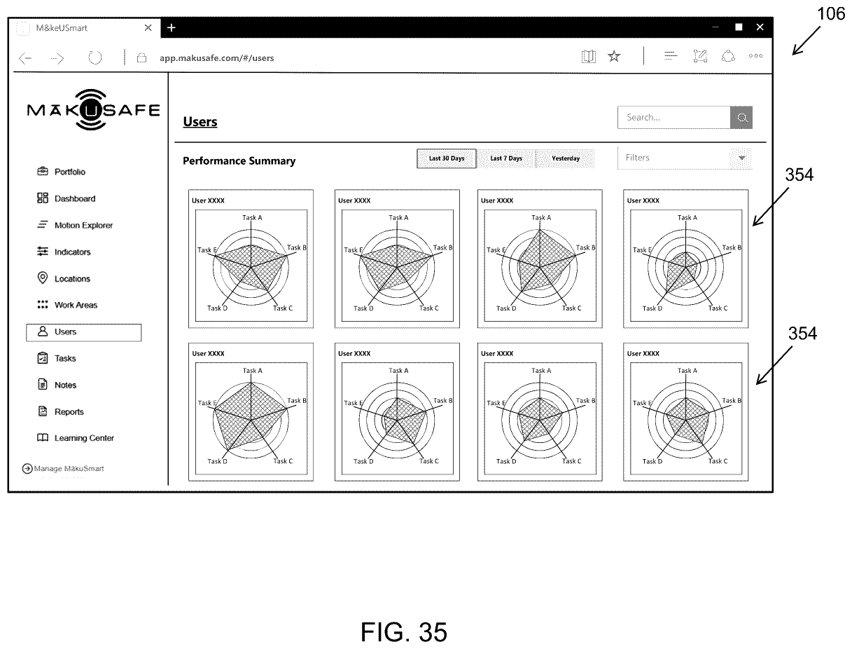

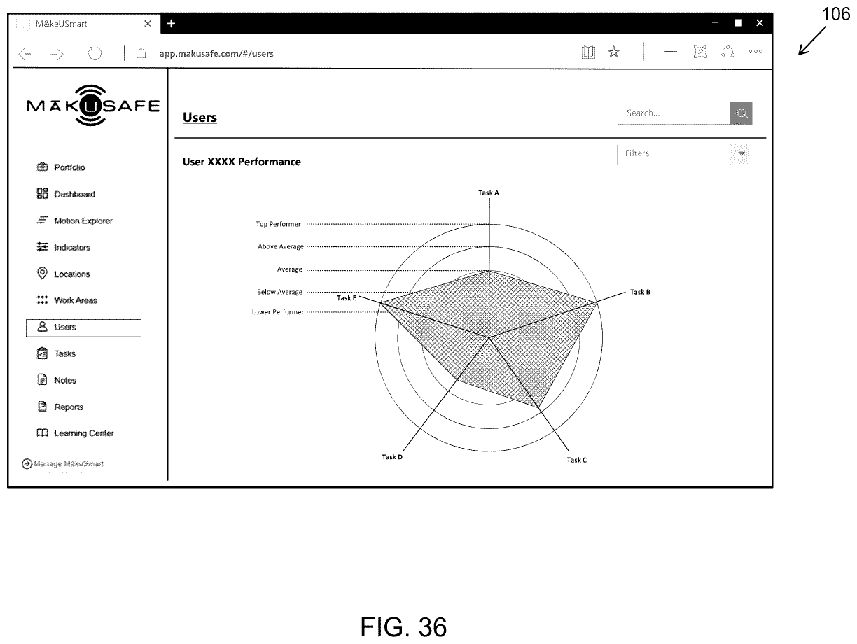

Referring now to FIG. 11, a high-level illustration of an exemplary computing device 1100 that can be used in accordance with the systems and methodologies disclosed herein is illustrated. For instance, the computing device 1100 may be used in a system that searches computer-readable indices. By way of another example, the computing device 1100 can be used in a system that dynamically generates content based upon textual input. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store images, videos, text, etc.

The computing device 1100 additionally includes a data store 1108 that is accessible by the processor 1102 by way of the system bus 1106. The data store 1108 may include executable instructions, computer-readable indices, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Technologies described herein relate to at least the following examples.
(A1) In an aspect, a method includes receiving a query from an application executing on a client computing device that is in network communication with the computing system. The method also includes, in response to receiving the query: 1) searching a computer-readable index of items based upon the query; 2) identifying an item based upon the searching of the computer-readable index; 3) transmitting the query to a computer-implemented model; and 4) obtaining content generated by the computer-implemented model, where the computer-implemented model generated the content based upon the query. The method also includes returning at least one of the item or the content to the client computing device for presentment by way of the application executing on the client computing device.
(A2) In some embodiments of the method of (A1), both the item and the content are returned to the client computing device in a search engine results page (SERP).
(A3) In some embodiments of the method of at least one of (A1)-(A2), the computer-implemented model is a diffuser model.
(A4) In some embodiments of the method of at least one of (A1)-(A3), the method also includes providing the query to a classifier that is trained to identify queries that are usable by the computer-implemented model to generate content, where the query is provided to the classifier prior to transmitting the query to the computer-implemented model. The method also includes receiving an indication from the classifier that the query is usable by the computer-implemented model to generate content, where the query is transmitted to the computer-implemented model based upon the indication from the classifier.
(A5) In some embodiments of the method of at least one of (A1)-(A4), the content is an image generated by the computer-implemented model.
(A6) In some embodiments of the method of (A5), the image is returned to the client computing device for presentment on a display of the client computing device. The method also includes receiving an indication that a second search is to be conducted based upon the content generated by the computer-implemented model. The method additionally includes searching the computer-readable index of items based upon the indication and the content. The method further includes identifying a second item based upon the searching of the computer-readable index of items. The method also includes returning the second item to the client computing device for presentment by way of the application executing on the client computing device.
(A7) In some embodiments of the method of (A6), the method also includes computing values for features of the content upon obtaining the content generated by the computer-implemented model, wherein the computer-readable index of items is searched based upon the computed values for the features of the content.
(A8) In some embodiments of the method of at least one of (A1)-(A7), the item is returned to the client computing device for presentment by way of the application executing on the client computing device at a first point in time. The method also includes generating a query suggestion based upon the query. The method further includes returning the query suggestion to the client computing device together with the item for presentment by way of the application executing on the client computing device. The method additionally includes returning the content to the client computing device at a second point in time that is subsequent to the first point in time and without further user interaction.
(A9) In some embodiments of the method (A8), the computing system causes the client computing device to cease presenting the query suggestion upon the content being returned to the client computing device.
(A10) In some embodiments of the method of at least one of (A1)-(A9), the method also includes accessing search history associated with a user of the client computing device, where the query is transmitted to the computer-implemented model based upon the search history associated with the user of the client computing device.
(A11) In some embodiments of the method of at least one of (A1)-(A10), the application is a productivity application.
(B1) In another aspect, a method performed by a computing system includes receiving a query from an application executing on a client computing device that is in network communication with the computing system. The method also includes returning a search results page to the client computing device for presentment by way of the application based upon the query. The search results include a search result identified based upon the query and a selectable button that corresponds to generation of content based upon the query. The method additionally includes receiving an indication from the client computing device that the selectable button has been selected. The method also includes providing the query to a computer-implemented model based upon the indication, where the computer-implemented model generates content based upon the query. The method further includes returning the content to the client computing device for presentment by way of the application.
(B2) In some embodiments of the method of (B1), the method is performed by a general-purpose web search engine that is executing on the computing system.
(B3) In some embodiments of the method of at least one of (B1)-(B2), the method also includes providing the query to a computer-implemented classifier, where the computer-implemented classifier generates an output that indicates that the query is usable by the computer-implemented model to generate the content. The selectable button is included in the search results page based upon the output generated by the computer-implemented classifier.
(B4) In some embodiments of the method of at least one of (B1)-(B3), the content is a video.
(B5) In some embodiments of the method of at least one of (B1)-(B4), the method also includes receiving, from the application, a request to search a computer-readable index based upon the content subsequent to returning the content to the client computing device for presentment by way of the application. The method also includes identifying an item in the computer-readable index based upon the content responsive to receiving the request. The method further includes returning a second search results page to the client computing device for presentment by way of the application, where the second search results page comprises the item.
(B6) In some embodiments of the method of at least one of (B1)-(B5), the computer-implemented model is a diffuser model.
(B7) In some embodiments of the method of at least one of (B1)-(B6), the method also includes determining that the computer-implemented model is to generate content on behalf of the user based upon a user profile of a user of the client computing device. The selectable button is included in the search results upon determining that the computer-implemented model is to generate the content on behalf of the user.
(C1) In yet another aspect, a method includes receiving, at a general-purpose web search engine, a query from a client computing device. The method also includes providing the query to a computer-implemented classifier, wherein the computer-implemented classifier is trained to identify queries that are to be provided to a computer-implemented model that generates images based upon the queries. The method additionally includes obtaining an output from the computer-implemented classifier that indicates that the query is to be provided to the computer-implemented model. The method further includes providing the query to the computer-implemented model based upon the output from the computer-implemented classifier. The method also includes obtaining a first image from the computer-implemented model, where the computer-implemented model generated the image based upon the query. The method additionally includes identifying a search result based upon the query. The method further includes generating a search engine results page (SERP), where the SERP includes the image generated by computer-implemented model and the search result. The method also includes transmitting the SERP to the client computing device for presentment on a display of the client computing device.
(C2) In some embodiments of the method of (C1), the computer-implemented model is a diffuser model.
(D1) In another aspect, a computing system includes a processor and memory, where the memory stores instructions that, when executed by the processor, cause the processor to perform at least one of the methods disclosed herein (e.g., at least one of the methods of (A1)-(A11), (B1)-(B7), or (C1)-(C2)).
(E1) In yet another aspect, a computer-readable storage medium includes instructions that, when executed by a processor, cause the processor to perform at least one of the methods disclosed herein (e.g., at least one of the methods of (A1)-(A11), (B1)-(B7), or (C1)-(C2)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
receiving a query from an application executing on a client computing device that is in network communication with the computing system;
responsive to receiving the query:
searching a computer-readable index of items based upon the query;
identifying an item based upon the searching of the computer-readable index;
transmitting the query to a computer-implemented model; and
obtaining content generated by the computer-implemented model, where the computer-implemented model generated the content based upon the query; and
returning at least one of the item or the content to the client computing device for presentment by way of the application executing on the client computing device.

2. The computing system of claim 1, wherein both the item and the content are returned to the client computing device in a search engine results page (SERP).

3. The computing system of claim 1, wherein the computer-implemented model is a diffuser model.

4. The computing system of claim 1, the acts further comprising:
prior to transmitting the query to the computer-implemented model, providing the query to a classifier that is trained to identify queries that are usable by the computer-implemented model to generate content;
receiving an indication from the classifier that the query is usable by the computer-implemented model to generate content, wherein the query is transmitted to the computer-implemented model based upon the indication from the classifier.

5. The computing system of claim 1, wherein the content is an image generated by the computer-implemented model.

6. The computing system of claim 5, wherein the image is returned to the client computing device for presentment on a display of the client computing device, the acts further comprising:
receiving an indication that a second search is to be conducted based upon the content generated by the computer-implemented model;
based upon the indication and the content, searching the computer-readable index of items;
identifying a second item based upon the searching of the computer-readable index of items; and
returning the second item to the client computing device for presentment by way of the application executing on the client computing device.

7. The computing system of claim 6, the acts further comprising:
computing values for features of the content upon obtaining the content generated by the computer-implemented model, wherein the computer-readable index of items is searched based upon the computed values for the features of the content.

8. The computing system of claim 1, wherein the item is returned to the client computing device for presentment by way of the application executing on the client computing device at a first point in time, the acts further comprising:
generating a query suggestion based upon the query;
returning the query suggestion to the client computing device together with the item for presentment by way of the application executing on the client computing device; and
at a second point in time that is subsequent to the first point in time, and without further user interaction, returning the content to the client computing device.

9. The computing system of claim 8, wherein the computing system causes the client computing device to cease presenting the query suggestion upon the content being returned to the client computing device.

10. The computing system of claim 1, the acts further comprising:
accessing search history associated with a user of the client computing device, wherein the query is transmitted to the computer-implemented model based upon the search history associated with the user of the client computing device.

11. The computing system of claim 1, wherein the application is a productivity application.

12. A method performed by computing system, the method comprising:
receiving a query from an application executing on a client computing device that is in network communication with the computing system;
based upon the query, returning a search results page to the client computing device for presentment by way of the application, wherein the search results page comprises:
a search result identified based upon the query; and
a selectable button that corresponds to generation of content based upon the query;
receiving an indication from the client computing device that the selectable button has been selected;
based upon the indication, providing the query to a computer-implemented model, wherein the computer-implemented model generates content based upon the query; and
returning the content to the client computing device for presentment by way of the application.

13. The method of claim 12 performed by a general-purpose web search engine that is executing on the computing system.

14. The method of claim 12, further comprising:
providing the query to a computer-implemented classifier, wherein the computer-implemented classifier generates an output that indicates that the query is usable by the computer-implemented model to generate the content, wherein the selectable button is included in the search results page based upon the output generated by the computer-implemented classifier.

15. The method of claim 12, wherein the content is a video.

16. The method of claim 12, further comprising:
subsequent to returning the content to the client computing device for presentment by way of the application, receiving, from the application, a request to search a computer-readable index based upon the content;
responsive to receiving the request, identifying an item in the computer-readable index based upon the content; and
returning a second search results page to the client computing device for presentment by way of the application, wherein the second search results page comprises the item.

17. The method of claim 12, wherein the computer-implemented model is a diffuser model.

18. The method of claim 12, further comprising:
based upon a user profile of a user of the client computing device, determining that the computer-implemented model is to generate content on behalf of the user, wherein the selectable button is included in the search results upon determining that the computer-implemented model is to generate the content on behalf of the user.

19. A computer-readable storage medium comprising instructions that, when executed by a processor, cause the processor to perform acts comprising:
receiving, at a general-purpose web search engine, a query from a client computing device;
providing the query to a computer-implemented classifier, wherein the computer-implemented classifier is trained to identify queries that are to be provided to a computer-implemented model that generates images based upon the queries;
obtaining an output from the computer-implemented classifier that indicates that the query is to be provided to the computer-implemented model;
based upon the output from the computer-implemented classifier, providing the query to the computer-implemented model;
obtaining a first image from the computer-implemented model, wherein the computer-implemented model generated the image based upon the query;
identifying a search result based upon the query;
generating a search engine results page (SERP), wherein the SERP includes the image generated by computer-implemented model and the search result; and
transmitting the SERP to the client computing device for presentment on a display of the client computing device.

20. The computer-readable storage medium of claim 19, wherein the computer-implemented model is a diffuser model.
